(19) United States
(12) Patent Application Publication
(10) Pub. No.: US 2025/0214360 A1
(43) Pub. Date: Jul. 3, 2025

(54) PRINTING APPARATUS, PRINTING METHOD, AND TEST PATTERN

(71) Applicant: SEIKO EPSON CORPORATION, Tokyo (JP)

(72) Inventors: Kimitaka KAMIJO, SHIOJIRI-SHI (JP); Takamitsu KONDO, AZUMINO-SHI (JP); Kazuaki SAKURADA, SUWA-SHI (JP)

(21) Appl. No.: 19/002,181

(22) Filed: Dec. 26, 2024

(30) Foreign Application Priority Data
Dec. 27, 2023 (JP) 2023-220610

(51) Int. Cl. B41J 29/393; B41J 2/21

(52) U.S. Cl. CPC B41J 29/393; B41J 2/2135; B41J 2029/3935

(57) ABSTRACT

A printing apparatus includes a printing head configured to eject a colored liquid onto a medium, and a printing control unit configured to control ejection of the colored liquid from the printing head to print a test pattern on the medium, the test pattern being for determining an upper limit value of an ejection amount of the colored liquid that can be ejected for printing an image, wherein the test pattern includes at least one patch, the patch includes a colored region to which the colored liquid is ejected and a blank region to which the colored liquid is not ejected, the blank region has a predetermined shape and is located on an inner side of the patch, and the colored region is arranged to surround the blank region and is adjacent to an outer side of the blank region.

The present application is based on, and claims priority from JP Application Serial Number 2023-220610, filed Dec. 27, 2023, the disclosure of which is hereby incorporated by reference herein in its entirety.

### BACKGROUND

### 1. Technical Field

The present disclosure relates to a printing apparatus, a printing method, and a test pattern.

### 2. Related Art

An inkjet printer, which is one of the printing apparatuses, ejects a colored liquid onto a medium such as fabric or paper from a nozzle provided in a printing head to form an image on the medium. If the amount of liquid to be ejected is too large, smearing of the colored liquid occurs, and a high-quality image cannot be formed. In this regard, JP-A-2017-42928 discloses printing a test pattern in which two types of colors are arranged adjacent to each other in order to confirm occurrence of smearing.

Focusing on the outer edge of the patch included in the test pattern disclosed in JP-A-2017-42928 described above, it is not impossible to confirm occurrence of smearing at the boundary between a region where the colored liquid is ejected and a region where the colored liquid is not ejected. However, the test pattern described in JP-A-2017-42928 is mainly aimed at confirming the occurrence of smearing at the boundary between two adjacent colors, and is not necessarily suitable for confirming the occurrence of smearing at the boundary between the region where the colored liquid is ejected and the region where the colored liquid is not ejected. For example, in a case where the boundary is made longer in order to more easily confirm the smearing at the boundary, the size of the patch inevitably increases. In this case, the usage amount of the medium and the liquid required for printing the test pattern increases, and a large amount of medium and liquid are consumed. With the occurrence of such a problem as one exemplary reason, provision of a test pattern suitable for confirming occurrence of smearing at a boundary between a region where a colored liquid is ejected and a region where the colored liquid is not ejected is demanded.

### SUMMARY

A printing apparatus according to the present disclosure includes a printing head configured to eject a colored liquid onto a medium, and a printing control unit configured to control ejection of the colored liquid from the printing head to print a test pattern on the medium, the test pattern being for determining an upper limit value of an ejection amount of the colored liquid that is able to be ejected for printing an image, wherein the test pattern includes at least one patch, the patch includes a colored region to which the colored liquid is ejected and a blank region to which the colored liquid is not ejected, the blank region has a predetermined shape and is located on an inner side of the patch, and the colored region is arranged to surround the blank region and is adjacent to an outer side of the blank region.

Furthermore a printing method according to the present disclosure includes controlling ejection of a colored liquid from a printing head configured to eject the colored liquid onto a medium, and printing a test pattern on the medium, the test pattern being for determining an upper limit value of an ejection amount of the colored liquid that is able to be ejected for printing an image, wherein the test pattern includes at least one patch, the patch includes a colored region to which the colored liquid is ejected and a blank region to which the colored liquid is not ejected, the blank region has a predetermined shape and is located on an inner side of the patch, and the colored region is arranged to surround the blank region and is adjacent to an outer side of the blank region.

Moreover, a test pattern according to the present disclosure is for determining an upper limit value of an ejection amount of a colored liquid that is able to be ejected for printing an image, the test pattern including at least one patch, wherein the patch includes a colored region to which the colored liquid is ejected and a blank region to which the colored liquid is not ejected, the blank region has a predetermined shape and is located on an inner side of the patch, and the colored region is arranged to surround the blank region and is adjacent to an outer side of the blank region.

### BRIEF DESCRIPTION OF THE DRAWINGS

FIG. 1 is a block diagram illustrating an example of a printing apparatus according to an embodiment.

FIG. 2 is a schematic diagram illustrating an example of a test pattern according to the embodiment.

FIG. 3 is a schematic diagram illustrating an example of another test pattern according to the embodiment.

FIG. 4 is a sequence chart illustrating an example of a flow of printing using the printing apparatus according to the embodiment.

FIG. 5 is a schematic diagram illustrating an example of a color bar.

FIG. 6 is a schematic diagram illustrating an example of a test pattern according to a first modified example.

FIG. 7 is a schematic diagram illustrating an example of a test pattern according to a second modified example.

FIG. 8 is a schematic diagram illustrating an example of a test pattern according to a third modified example.

FIG. 9 is a schematic diagram illustrating an example of a test pattern according to a fourth modified example.

FIG. 10 is a schematic diagram illustrating an example of a test pattern according to a fifth modified example.

FIG. 11 is a schematic diagram illustrating an example of a test pattern according to a sixth modified example.

FIG. 12 is a schematic diagram illustrating an example of a test pattern T3 according to a seventh modified example.

FIG. 13 is a block diagram illustrating an example of a hardware configuration of a computer included in the printing apparatus according to the embodiment or the modified example.

### DESCRIPTION OF EMBODIMENTS

Each embodiment will be described below with reference to the drawings. For clarity of description, the following description and drawings are omitted and simplified as appropriate. Furthermore, in each drawing, the same elements are denoted by the same reference numerals, and redundant description is omitted as necessary.

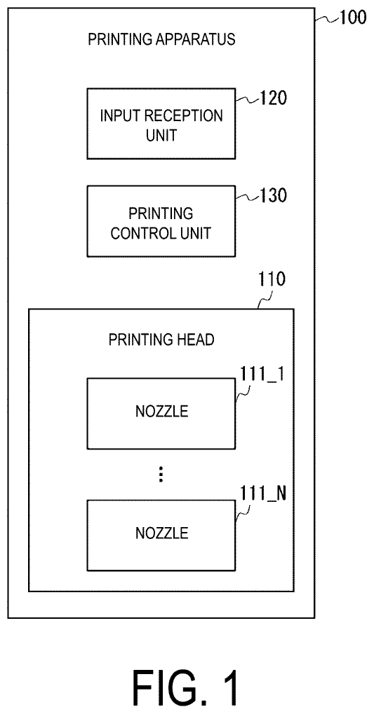

FIG. 1 is a block diagram illustrating an example of a configuration of a printing apparatus 100 according to an embodiment. The printing apparatus 100 is an ink jet printer and includes a printing head 110, an input reception unit 120, and a printing control unit 130. In the ink jet printer, the amount of ink that can be used for printing varies depending on the medium on which printing is performed. The upper limit of the usable ink amount is determined by whether or not smearing occurs. In the present embodiment, a test pattern suitable for confirming smearing will be described.

The printing head 110 ejects the colored liquid onto the medium to form an image on the medium. The colored liquid is also referred to as color ink. In the present embodiment, a medium on which an image is formed, that is, a medium on which printing is performed is, for example, a fabric. In other words, the printing apparatus 100 is, for example, a textile printing printer that performs printing on the fabric. The printing head 110 includes N types of nozzles 111_1 to 111_N for ejecting liquid used for printing. Note that N represents an integer of greater than or equal to two. In the following description, when the nozzles 111_1 to 111_N are referred to without being particularly distinguished, they are simply referred to as the nozzle 111.

For example, the printing head 110 may include n types of nozzles 111 to eject n types of different colored liquids. Note that n is an integer equal to or greater than one. That is, the N types of nozzles 111 may be configured to include n types of nozzles 111 for ejecting the colored liquid. For example, the printing head 110 may include four types of nozzles as nozzles for colored liquids in order to eject four types of colored liquids of cyan, magenta, yellow, and black.

Furthermore, the printing head 110 may further include a nozzle 111 for ejecting a functional liquid in addition to the nozzle 111 for ejecting the colored liquid. That is, the printing head 110 may include m different nozzles 111 to eject m different types of functional liquids. Note that m is an integer equal to or greater than 1. That is, the N types of nozzles 111 may be configured to further include m types of nozzles 111 for ejecting the functional liquid in addition to the n types of nozzles 111 for ejecting the colored liquid.

The functional liquid is also referred to as functional ink. Here, the functional liquid refers to a colorless liquid (transparent liquid) having a predetermined function for assisting formation of an image by a colored liquid. More specifically, the functional liquid is a liquid that acts on the colored liquid to improve the quality of the image formed on the medium as compared with a case where the functional liquid is not used. For example, the functional liquid may be a flocculant that aggregates a component of the colored liquid, that is, a pigment contained as a component of the ink composition. By using the flocculant, even when printing is performed on a medium such as a fabric in which the colored liquid permeates into the inside of the fiber, the pigment component can be aggregated before the colored liquid permeates deep into the fiber, and the color development can be further improved. Examples of the flocculant include a metal salt, an inorganic acid, an organic acid, and a cationic compound, and examples of the cationic compound include a cationic resin (cationic polymer) and a cationic surfactant. Moreover, the functional liquid may be a softener that imparts softness to a medium such as a fabric. As the softener, for example, particles containing organopolysiloxane, fatty acid esters, dialkyl dimethyl ammonium salts, imidazoline type surfactants, and amphoteric surfactants can be used. The functional liquid may be a coating liquid that imparts rubbing resistance to the region where the colored liquid is ejected. As the coating liquid, for example, a liquid containing anionic resin particles and water can be used.

The input reception unit 120 receives an input to the printing apparatus 100. For example, the input reception unit 120 receives an input instructing printing. Specifically, for example, the input reception unit 120 receives an input instructing printing of a test pattern to be described later. In addition, the input reception unit 120 may receive an input of an instruction to print a color bar described later. Furthermore, the input reception unit 120 may receive an input instructing printing of a user image. Here, the user image is an arbitrary image that the user desires to print on the medium, and refers to an image other than the test pattern and the color bar prepared by the user. The input reception unit 120 may receive an input designating an upper limit value of the liquid to be ejected from the printing head 110.

The input reception unit 120 receives, for example, an input from a terminal device such as a smartphone, a tablet, or a personal computer communicably connected to the printing apparatus 100. The input received by the input reception unit 120 may not necessarily be an input from another device such as a terminal device. For example, the input reception unit 120 may receive a printing instruction or the like input via an operation panel provided in the printing apparatus 100.

The printing control unit 130 controls the ejection of the colored liquid from the printing head 110 to print an image on the medium. Note that when the printing head 110 is also capable of ejecting the functional liquid, that is, when the printing head 110 includes the nozzles 111 for ejecting the functional liquid, the printing control unit 130 controls ejection of the functional liquid in addition to control of ejection of the colored liquid from the printing head 110. When the functional liquid is also ejected, the functional liquid is ejected to the same position as the eject position of the colored liquid. However, the eject position of the functional liquid may not be completely the same as the eject position of the colored liquid. For example, the functional liquid may not be ejected to all the eject positions of the colored liquid, and may be ejected to a range wider than the eject positions of the colored liquid.

In the present embodiment, in particular, the printing control unit 130 controls the ejection of the liquid from the printing head 110 to print the test pattern on the medium. The test pattern printed in the present embodiment is a test pattern for determining the upper limit value of the ejection amount of the colored liquid that can be ejected for printing an image. As the amount of the colored liquid ejected from the printing head 110 increases, the smearing of the colored liquid easily occurs on the medium. Furthermore, the case of occurrence of smearing varies depending on the medium used for printing. Thus, the printing control unit 130 prints a test pattern on the medium in order to confirm how much the colored liquid is ejected to cause smearing on the medium used for printing. Then, the user who has seen the print result of the test pattern visually confirms the occurrence of smearing, and determines the amount of liquid that can be ejected to the medium. Note that a configuration of a specific test pattern will be described later.

For example, when the input reception unit 120 receives an input instructing printing of a test pattern, the printing control unit 130 executes a control process of printing a predetermined test pattern. Furthermore, when the input reception unit 120 receives an input instructing printing of a color bar, the printing control unit 130 executes a control process of printing a predetermined color bar. When the input reception unit 120 receives an input instructing printing of a user image, the printing control unit 130 executes a control process of printing a user image. When printing of a color bar and printing of a user image are performed, the printing control unit 130 executes printing so as not to exceed the upper limit value of the liquid ejection amount determined based on the print result of the test pattern.

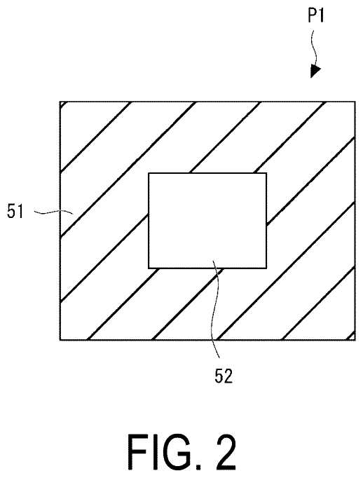

The test pattern printed by the printing apparatus 100 includes at least one patch. FIG. 2 is a schematic diagram illustrating an example of a test pattern to be printed. The test pattern printed by the printing apparatus 100 includes, for example, a patch P1 as illustrated in FIG. 2. The patch P1 includes a colored region 51 to which the colored liquid is ejected and a blank region 52 to which the colored liquid is not ejected. Here, the blank region 52 has a predetermined shape and is located on the inner side of the patch P1. Then, the colored region 51 is arranged so as to surround the blank region 52, and is adjacent to the outer side of the blank region 52.

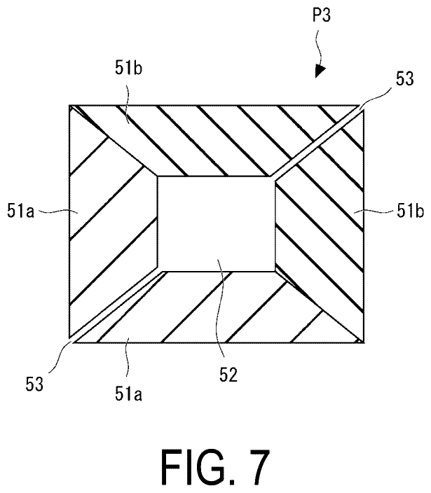

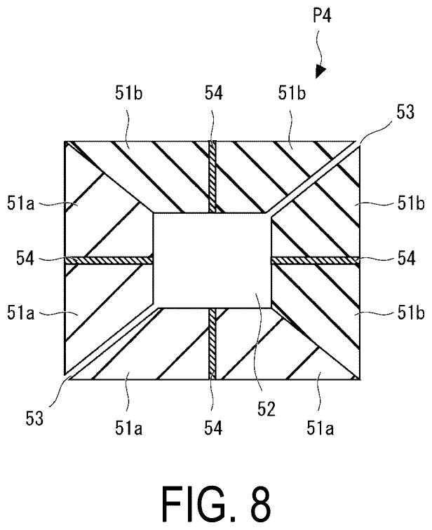

Note that, in the example illustrated in FIG. 2, the blank region 52 is continuously surrounded by the colored region 51, but may not necessarily be continuously surrounded by the colored region 51 as in FIGS. 7 and 8 to be described later. That is, the blank region 52 may not be surrounded by the complete annular colored region 51, and may be surrounded by the substantially annular colored region 51. That is, the blank region 52 may be surrounded by the partially torn annular colored region 51.

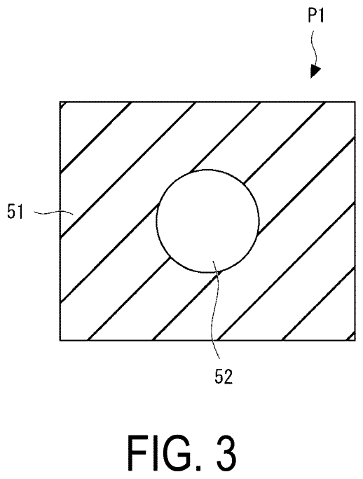

Furthermore, in the example illustrated in FIG. 2, the shape of the blank region 52 is a rectangular shape, but may not necessarily be a rectangular shape. That is, the predetermined shape described above is not limited to a rectangular shape. However, since the shape of the blank region 52 is a rectangular shape, the boundary between the blank region 52 and the colored region 51 becomes a straight line, so that the degree of smearing can be easily visually recognized. Therefore, the blank region 52 preferably has a rectangular shape. However, for example, as illustrated in FIG. 3, the predetermined shape may be a circular shape. Note that the predetermined shape is preferably a figure having symmetry so that the occurrence of smearing at the boundary between the region to which the colored liquid is ejected and the region to which the colored liquid is not ejected can be easily visually recognized.

Note in the following description, the smearing at the boundary between the region to which the colored liquid is ejected and the region to which the colored liquid is not ejected is referred to as an ejection boundary smearing. In a case where the patch P1 is printed as the test pattern, the ejection boundary smearing can be confirmed by confirming the boundary between the blank region 52 and the colored region 51. In addition, since the colored liquid is not ejected to the outer side of the test pattern, that is, the outer side of the colored region 51 of the patch P1, the occurrence of the ejection boundary smearing can be confirmed by confirming the outer periphery of the test pattern, that is, the outer periphery of the patch P1. Note that when the test pattern is printed, the functional liquid may be further ejected to a part of or the whole of the colored region 51. The same applies to the modified example described later.

For example, the printing control unit 130 ejects the colored liquid of the ejection amount designated by the printing instruction of the test pattern from the printing head 110 to form the colored region 51. As a result, occurrence of smearing when the colored liquid is ejected to the medium at the ejection amount can be confirmed. In particular, in the present embodiment, a test pattern including a patch P1 in which the blank region 52 is arranged on the inner side of the colored region 51 and the colored region 51 is arranged on the outer side of the blank region 52 is printed. Therefore, it is possible to confirm the occurrence of the ejection boundary smearing by using the outer peripheral portion of the blank region 52. That is, according to the present embodiment, it is not necessary to confirm the occurrence of the ejection boundary smearing by relying only on the outer peripheral portion of the patch. Therefore, the occurrence of the ejection boundary smearing can be confirmed without increasing the patch size in order to sufficiently secure the length of the boundary between the region where the colored liquid is ejected and the region where the colored liquid is not ejected. Furthermore, in particular, in the present embodiment, the blank region 52 is surrounded by the colored region 51 on the four sides. That is, the upper side, the lower side, the left side, and the right side of the blank region 52 are in contact with the colored region 51. Therefore, the occurrence of the ejection boundary smearing can be easily confirmed as a change in the predetermined shape of the blank region 52. Furthermore, the smearing in the up-down direction and the smearing in the left-right direction can be easily confirmed by merely focusing on the shape of the blank region 52.

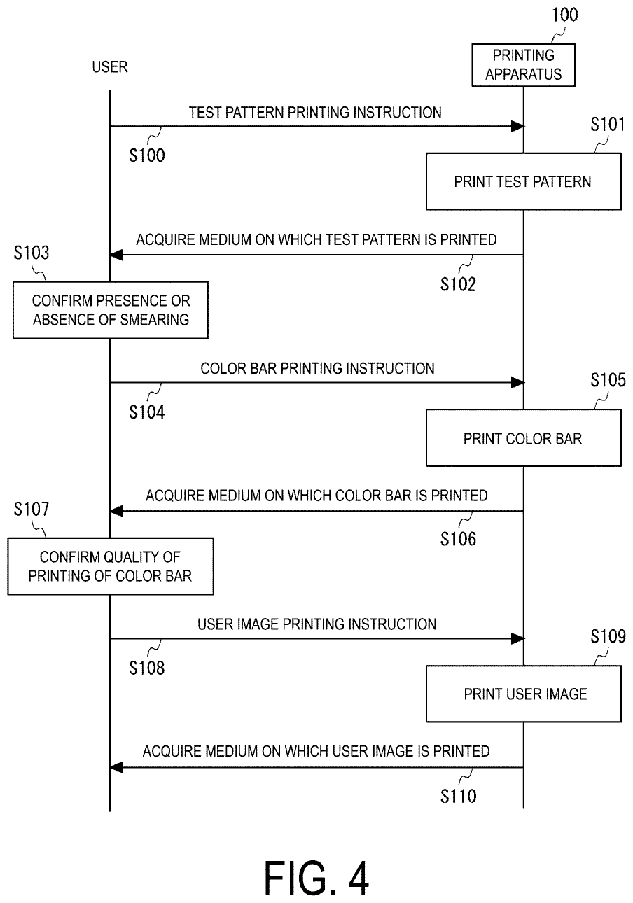

FIG. 4 is a sequence chart illustrating an example of a flow of printing using the printing apparatus 100. Hereinafter, a flow of printing using the printing apparatus 100 will be described with reference to FIG. 4.

In step S100, the user instructs the printing apparatus 100 to print a test pattern. As a result, the input reception unit 120 of the printing apparatus 100 receives an input instructing printing of the test pattern. Note that, as described above, in this step and a step to be described later, an instruction from the user may be input via an operation panel or the like provided in the printing apparatus 100, or may be input to the printing apparatus 100 via a terminal device connected to the printing apparatus 100. In addition, in this input, the amount of colored liquid to be ejected to form the test pattern may be designated. In this case, the amount of colored liquid to be ejected to form the test pattern may be designated, for example, by designating a ratio with respect to the maximum ejectable amount. Furthermore, in this step and a step to be described later, the print data (print data of a test pattern, a color bar, or a user image) of the image to be printed may be generated by the terminal device. Next, in step S101, the printing control unit 130 controls the ejection of liquid from the printing head 110 and prints a test pattern on the medium.

Next, in step S102, the user acquires the medium on which the test pattern is printed. In step S103, the user visually confirms the presence or absence of smearing in the printed test pattern. Thus, the user determines the upper limit value of the ejection amount of the colored liquid at which printing can be performed without smearing. Note that in order to determine the upper limit value at which printing can be performed without smearing, step $100 to step S103 described above may be repeated while changing the ejection amount for printing the test pattern.

After the upper limit value of the ejection amount of the colored liquid is determined, in step S104, the user instructs the printing apparatus 100 to print the color bar to further confirm that there is no problem in printing by adopting the determined upper limit value. More specifically, the printing apparatus 100 is instructed to perform printing with the upper limit value determined in step S103 as the upper limit value of the colored liquid ejected from the printing head 110. As a result, the input reception unit 120 of the printing apparatus 100 receives an input instructing printing of the color bar. Next, in step $105, the printing control unit 130 ejects a colored liquid of an amount less than or equal to the determined upper limit value to print a color bar on the medium.

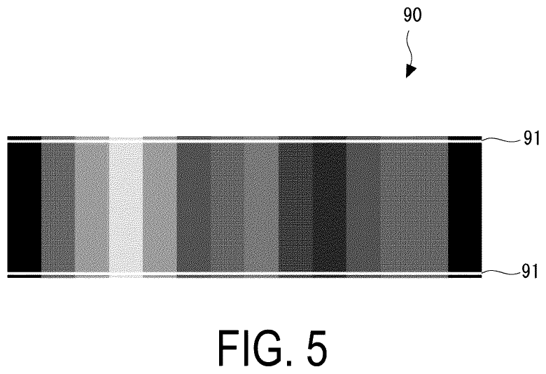

FIG. 5 is a schematic diagram illustrating an example of a color bar to be printed. As illustrated in FIG. 5, the printing control unit 130 prints, for example, a color bar 90 including a large number of bars of different colors. Note that the color bar 90 may be formed by ejecting not only the colored liquid but also the functional liquid. In addition, the color bar 90 may include a blank line 91 to which the colored liquid is not ejected. Note that the size of the color bar 90 to be printed may be larger than the size of the test pattern so that the quality of printing can be easily confirmed.

After step S105, in step S106, the user acquires the medium on which the color bar is printed. Then, in step S107, the user confirms the quality of printing of the color bar. Note that step S100 to step S107 described above may be repeated in order to obtain the desired print quality.

After confirmed that the desired print quality is obtained, in step S108, the user instructs the printing apparatus 100 to print the user image. More specifically, the printing apparatus 100 is instructed to perform printing with the upper limit value determined in step S103 as the upper limit value of the colored liquid ejected from the printing head 110. As a result, the input reception unit 120 of the printing apparatus 100 receives an input instructing printing of the user image. Next, in step S109, the printing control unit 130 ejects the colored liquid of an amount less than or equal to the determined upper limit value to print the user image on the medium. Then, in step S110, the user acquires the medium on which the user image is printed.

As described above, in the present embodiment, the test pattern including the patch P1 in which the blank region 52 is arranged on the inner side of the colored region 51 and the colored region 51 is arranged on the outer side of the blank region 52 is printed. As a result, the occurrence of the ejection boundary smearing can be easily confirmed by confirming the smearing at the outer periphery of the blank region 52. That is, according to the present embodiment, a test pattern suitable for confirming the occurrence of the ejection boundary smearing can be provided.

Next, a modified example of the test pattern will be described. In the following description, a configuration different from the above-described test pattern will be described, and the description on the redundant configuration will be appropriately omitted.

### First Modified Example

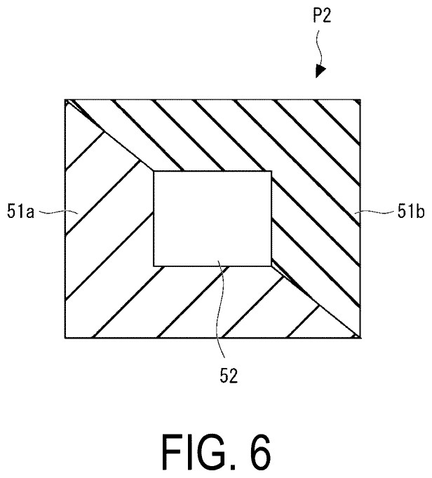

The patch P1 of the test pattern illustrated in FIG. 2 or 3 included a colored region 51 of one color. However, the colored region of the patch may be constituted by a plurality of regions having different colors. FIG. 6 is a schematic diagram illustrating an example of a test pattern according to a first modified example. The test pattern to be printed may include, for example, a patch P2 as illustrated in FIG. 6. The patch P2 includes a colored region including a first partial region 51a of a first color and a second partial region 51b of a second color different from the first color. The first partial region 51a and the second partial region 51b are adjacent to each other. That is, in the patch P2, the colored region is divided into the first partial region 51a and the second partial region 51b having different colors. Note that, in the example illustrated in FIG. 6, the shape of the blank region 52 of the patch P2 is a rectangle, but may be other shapes as with the patch P1.

The following effects can be further obtained in addition to the effects of the patch P1 described above by printing the test pattern including the patch P2. Since the first partial region 51a and the second partial region 51b are adjacent to each other, not only the ejection boundary smearing but also the smearing at the boundary between the regions where the colored liquids of different colors are ejected can be confirmed by confirming the boundary between the two. Hereinafter, the smearing at the boundary between the regions where the colored liquids of different colors are ejected is referred to as color boundary smearing. Note that in the example illustrated in FIG. 6, the colored region is constituted by partial regions of two colors, but may be constituted by partial regions of three or more colors.

### Second Modified Example

Next, a second modified example of the test pattern will be described. FIG. 7 is a schematic diagram illustrating an example of a test pattern according to a second modified example. The test pattern to be printed may include, for example, a patch P3 as illustrated in FIG. 7. The patch P3 is different from the patch P2 described above in that the patch P3 further includes a blank line 53 which is a linear region to which a colored liquid is not ejected. The blank line 53 is arranged so as to divide each of the first partial region 51a and the second partial region 51b. The colored region (first partial region 51a or second partial region 51b) is adjacent to both sides of the blank line 53. Note that, in the example illustrated in FIG. 7, the blank line 53 is arranged so as to pass from the blank region 52 to the outside of the patch P3, but the blank line 53 may be arranged so as to divide the colored region and may not necessarily be coupled to the blank region 52. Furthermore, in the example illustrated in FIG. 7, the blank line 53 is arranged in both the first partial region 5 la and the second partial region 51b, but may be arranged in only one of the first partial region and the second partial region.

By printing the test pattern including the patch P3 having the blank line 53, not only the ejection boundary smearing using the blank region 52 but also the ejection boundary smearing using the blank line 53 can be confirmed. Therefore, the ejection boundary smearing can be more easily confirmed. Note that, here, an example in which the blank line 53 is added to the patch P2 is illustrated as the patch P3, but of course, the blank line 53 may be added to the patch P1.

### Third Modified Example

Next, a third modified example of the test pattern will be described. FIG. 8 is a schematic diagram illustrating an example of a test pattern according to a third modified example. The test pattern to be printed may include, for example, a patch P4 as illustrated in FIG. 8. The patch P4 is different from the above-described patch P3 in that the patch P4 further includes a colored line 54 which is a linear region to which the colored liquid is ejected. The colored line 54 is arranged so as to divide each of the first partial region 51a and the second partial region 51b. The colored region (first partial region 51a or second partial region 51b) is adjacent to both sides of the colored line 54.

The color of the colored line 54 is different from the color of the adjacent colored region. That is, the color of the colored line 54 is a predetermined color different from the color of the first partial region 51a and the color of the second partial region 51b. The color of the colored line 54 may be a color that is likely to cause smearing with the color used for the colored region (the first partial region 51a or the second partial region 51b). The boundary between the region containing the yellow component and the region containing the black component is likely to cause color boundary smearing. Therefore, when the yellow component is used in the colored region, the color of the colored line 54 adjacent to the colored region may be black. Similarly, when the black component is used in the colored region, the color of the colored line 54 adjacent to that colored region may be yellow.

Note that, in the example illustrated in FIG. 8, the colored line 54 is arranged so as to pass from the blank region 52 to the outside of the patch P4, but the colored line 54 merely needs to be arranged so as to divide the colored region and may not necessarily be coupled to the blank region 52. Furthermore, in the example illustrated in FIG. 8, the colored line 54 is arranged in both the first partial region 51a and the second partial region 51b, but may be arranged in only one of the first partial region and the second partial region.

By printing the test pattern including the patch P4 having the colored line 54, not only the color boundary smearing between the color of the first partial region 51a and the color of the second partial region 51b, but also the color boundary smearing between the color of the colored line 54 and the color of the first partial region 51a and the color boundary smearing between the color of the colored line 54 and the color of the second partial region 51b can also be confirmed. Note that, here, an example in which the colored line 54 is added to the patch P3 has been illustrated as the patch P4, but of course, the colored line 54 may be added to the patch P1 or the patch P2.

### Fourth Modified Example

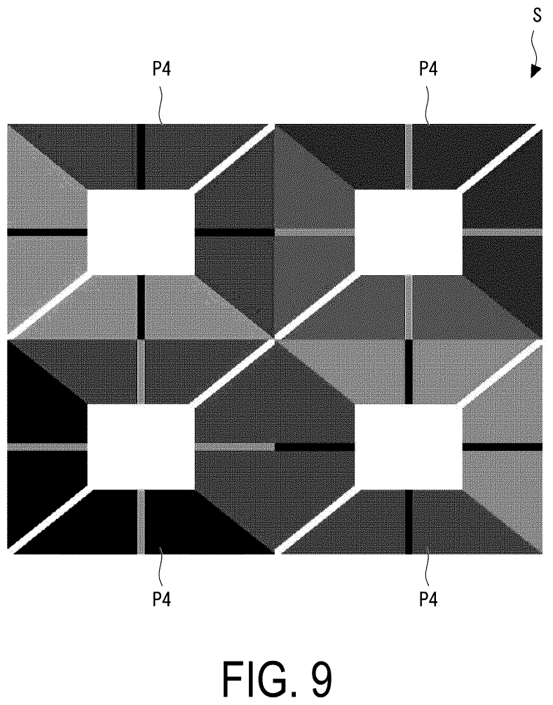

Next, a fourth modified example of the test pattern will be described. FIG. 9 is a schematic diagram illustrating an example of a test pattern according to a fourth modified example. The test pattern to be printed may include a patch set S in which a plurality of patches P4 are coupled as illustrated in FIG. 9. In the example illustrated in FIG. 9, the patch set S is configured by coupling four patches P4. Note that in order to be able to confirm the color boundary smearing in various color combinations by the patch set S, the color combinations of the first partial region 51a and the second partial region 51b constituting each patch P4 included in the patch set S are preferably different from each other.

The color boundary smearing for various colors can be easily confirmed by printing the test pattern including the patch set S. Note that although the patch set S configured using the patch P4 is illustrated here, the patch set may be configured using any one of the patch P1, the patch P2, and the patch P3 instead of the patch P4.

### Fifth Modified Example

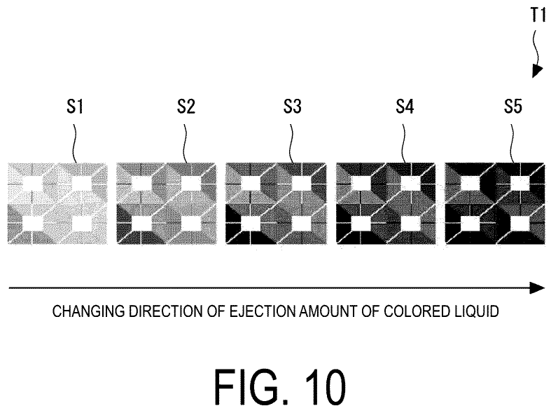

Next, a fifth modified example of the test pattern will be described. FIG. 10 is a schematic diagram illustrating an example of a test pattern T1 according to a fifth modified example. The test pattern T1 illustrated in FIG. 10 includes a plurality of patch sets S1 to S5 having different amounts of colored liquid ejected per unit area. The configurations of the patch sets S1 to S5 are the same as those of the patch set S described above, but the amounts of the colored liquids ejected per unit area are different. In the example illustrated in FIG. 10, the patch sets S1 to S5 are aligned side by side in a predetermined direction so that the amount of colored liquid ejected per unit area is in ascending order. Specifically, the patch set S1 has the smallest amount of colored liquid ejected per unit area, and the patch set S5 has the largest amount of colored liquid ejected per unit area. Note that the patch sets S1 to S5 included in the test pattern T1 may be arranged side by side such that the amount of colored liquid ejected per unit area is in descending order. In the patch sets S1 to S5, the amounts of colored liquids ejected per unit area are preferably arranged side by side in ascending order or descending order, but may be arranged randomly.

In the example illustrated in FIG. 10, the test pattern T1 is printed in five stages of ejection amounts, but the test pattern T1 merely needs to be printed in at least two or more stages of ejection amounts. Furthermore, in the present modified example, various patches having different ejection amounts merely needs to be printed. Therefore, the patch set including the patch P4 does not necessarily need to be used, and the patch set including any of the patch P1, the patch P2, and the patch P3 may be used. In addition, various patches having different ejection amounts may not necessarily be printed as a patch set. That is, printing may be performed such that a plurality of patches having different amounts of colored liquid ejected for forming a patch are arranged side by side. In this case as well, the patch to be printed may be any of the patches P1 to P4. As described above, in the present modified example, the test pattern printed by the printing apparatus 100 may have a plurality of patches having different amounts of colored liquid ejected per unit area.

By printing such a test pattern, the user can confirm various patches having different conditions of the ejection amount of the colored liquid at one time, and thus can more easily confirm the upper limit value of the ejection amount that does not cause smearing. In the present modified example, in step S100 of the sequence chart described above, the range of the ejection amount of the colored liquid used for printing the patch of the test pattern may be designated. In this case, patches are printed with different ejection amounts within the designated range.

### Sixth Modified Example

Next, a sixth modified example of the test pattern will be described. In the embodiment and modified examples described above, the ejection of the functional liquid is not essential, but in the present modified example, the printing head 110 ejects the functional liquid to the same region as the region where the colored liquid is ejected. Therefore, in the present modified example, the printing control unit 130 controls the ejection of the colored liquid and the functional liquid from the printing head 110 to print the test pattern on the medium.

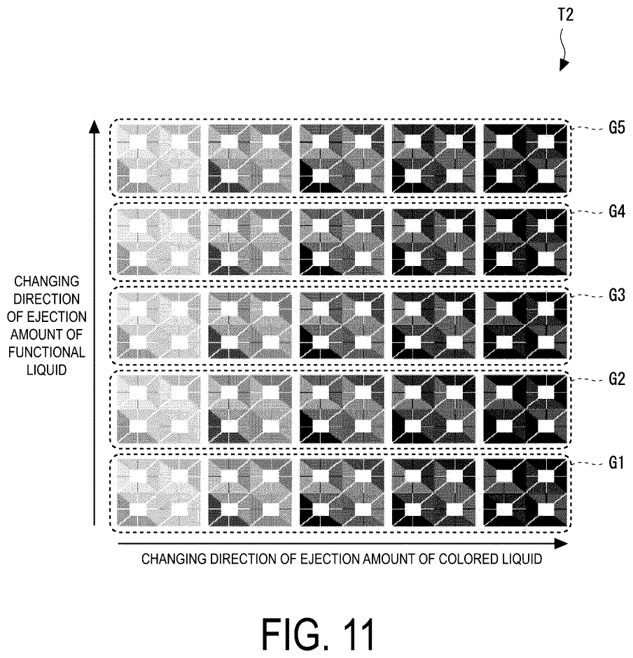

FIG. 11 is a schematic diagram illustrating an example of a test pattern T2 according to a sixth modified example. The test pattern T2 illustrated in FIG. 11 includes a plurality of patch groups G1 to G5 having different amounts of functional liquids ejected per unit area. The configurations of the patch groups G1 to G5 are the same as the configuration of the test pattern T1 illustrated in FIG. 10. That is, each of the patch groups G1 to G5 is configured by the patch sets S1 to S5 having different amounts of colored liquid illustrated in FIG. 10. That is, in each of the patch groups G1 to G5, the patch sets S1 to S5 are aligned side by side in a first direction such that the amount of colored liquid ejected per unit area is in ascending order. Note that the patch sets S1 to S5 may be aligned side by side in the first direction such that the amount of colored liquid ejected per unit area is in descending order.

Each of the patch groups G1 to G5 has a different amount of functional liquid ejected per unit area. In the example illustrated in FIG. 11, the patch groups G1 to G5 are aligned side by side in a second direction such that the amount of functional liquid ejected per unit area is in ascending order. Here, the second direction is a direction orthogonal to the above-described first direction. Specifically, the patch group G1 has the smallest amount of functional liquid ejected per unit area, and the patch group G5 has the largest amount of functional liquid ejected per unit area. The patch groups G1 to G5 included in the test pattern T2 may be aligned side by side in the second direction such that the amount of functional liquid ejected per unit area is in descending order.

In the example illustrated in FIG. 11, the test pattern T2 is printed with the colored liquid and the functional liquid both in five stages of ejection amounts, but the test pattern T2 merely needs to be printed in at least two or more stages of ejection amounts. Furthermore, in the present modified example, since various patches having different ejection amounts of the colored liquid and the functional liquid merely needs to be printed, the type of the patch configuring the patch set is not limited to the patch P4 in the present modified example as well, as in the fifth modified example. In addition, various patches having different ejection amounts do not necessarily need to be printed as a patch set, and the patch to be printed may be any of the patches P1 to P4. Such a variation of the present modified example can also be applied to a case where the test pattern of the present modified example is included as a partial test pattern in the seventh modified example described later.

As described above, in the present modified example, the test pattern printed by the printing apparatus 100 includes a plurality of patches in which the amount of colored liquid ejected per unit area and the amount of functional liquid ejected per unit area are different. In the test pattern, a plurality of patches having different amounts of colored liquid ejected per unit area are arranged side by side in a first order in the first direction. Here, the first order is descending order or ascending order of the amount of colored liquid. Furthermore, in the test pattern, a plurality of patches having different amounts of functional liquid ejected per unit area are arranged side by side in a second order in the second direction orthogonal to the first direction. Here, the second order is descending order or ascending order of the amount of functional liquid. More specifically, the test pattern T2 printed in the present modified example includes a plurality of patch groups each including a plurality of patches in which amount of functional liquid ejected per unit area is constant and amount of colored liquid ejected per unit area is different. In the plurality of patch groups GI to G5 included in the test pattern T2, the amount of functional liquid ejected per unit area is different from each other.

By printing such a test pattern, the presence or absence of ejection boundary smearing or color boundary smearing due to the difference in the amount of functional liquid can be confirmed. In particular, as described above, in the test pattern, the plurality of patches having different amounts of colored liquid are arranged side by side in the first order in the first direction, and the plurality of patches having different amounts of functional liquid are arranged side by side in the second order in the second direction. That is, the patches are aligned according to the ejection amount of the colored liquid and the ejection amount of the functional liquid. Therefore, when the user views and confirms the test pattern, the user can easily grasp an appropriate upper limit value of the ejection amount of the colored liquid and an appropriate upper limit value of the ejection amount of the functional liquid. In particular, when a functional liquid such as a flocculant is used, the image quality to be printed varies depending on the presence or absence of the functional liquid. According to the test pattern of the present modified example, since the user can easily confirm the difference in image quality due to the difference in the amount of functional liquid, the user can easily grasp an appropriate upper limit value of the ejection amount of the functional liquid for obtaining a desired image quality.

Note that in the present modified example, in step S100 of the sequence chart described above, the range of the ejection amount of the colored liquid and the range of the ejection amount of the functional liquid used for printing the patch of the test pattern may be designated. In this case, patches are printed with different ejection amounts within the designated range. Furthermore, in step S103, the user determines the upper limit of the ejection amount of the colored liquid and the upper limit of the functional liquid that can be printed without causing smearing. In step S105, the printing control unit 130 ejects the colored liquid and the functional liquid in amounts of less than or equal to the determined upper limit value to print the color bar on the medium. Similarly, in step S109, the printing control unit 130 ejects the colored liquid and the functional liquid in amounts less than or equal to the determined upper limit value to print the user image on the medium. Note that the description regarding the sequence chart in the present modified example is also applied to a seventh modified example described later.

### Seventh Modified Example

Next, a seventh modified example of the test pattern will be described. In a case where a plurality of types of functional liquids having different functions are used, the printing apparatus 100 may print a test pattern including a plurality of test patterns illustrated in the sixth modified example as partial test patterns.

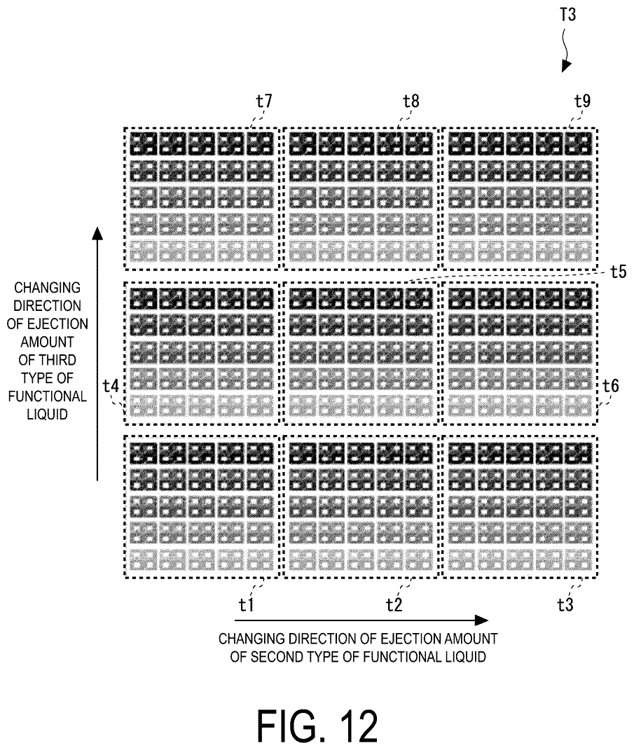

FIG. 12 is a schematic diagram illustrating an example of a test pattern T3 according to a seventh modified example. FIG. 12 illustrates an example of a test pattern in a case where three types of functional liquids are ejected. The test pattern T3 illustrated in FIG. 12 includes a plurality of partial test patterns t1 to t9. The configuration of each of the partial test patterns t1 to 19 is the same as the configuration of the test pattern T2 illustrated in FIG. 11. Here, in each partial test pattern, the ejection amount of a functional liquid other than a predetermined type of functional liquid among a plurality of types of functional liquids is fixed. The partial test patterns are different from each other only in the ejection amount of the functional liquid other than the predetermined functional liquid. That is, the test pattern T3 includes various partial test patterns t1 to t9 in which only the ejection amount of a type of functional liquid other than the predetermined functional liquid is changed. Specifically, each of the partial test patterns t1 to t9 includes a plurality of patches in which the ejection amount of a second type of functional liquid and the ejection amount of a third type of functional liquid are not changed and the ejection amount of the colored liquid and the ejection amount of a first type of functional liquid are changed. The plurality of partial test patterns t1 to 19 included in the test pattern are different from each other in the ejection amount of the second type of functional liquid or the ejection amount of the third type of functional liquid. Note that the partial test patterns t1 to t9 are arranged in the first direction such that the amount of the second type of functional liquid is in ascending order or descending order, and are arranged in the second direction orthogonal to the first direction such that the amount of the third type of functional liquid is in ascending order or descending order. Note that when there are two types of functional liquids used for printing, the arrangement of the partial test pattern in the second direction is omitted. In addition, in the example illustrated in FIG. 12, the test pattern T3 is printed with three stages of ejection amounts for both the second type of functional liquid and the third type of functional liquid, but the test pattern T3 merely needs to be printed with at least two or more stages of ejection amounts.

As described above, in the present modified example, the test pattern includes a plurality of partial test patterns. Each of the partial test patterns has a plurality of patch groups. Here, each of the patch groups is configured by a plurality of patches in which the amount of all types of functional liquids ejected per unit area is constant and the amount of colored liquid ejected per unit area is different. Furthermore, the plurality of patch groups are different from each other in the ejection amount of the first type of functional liquid ejected per unit area. In addition, in the plurality of partial test patterns, the ejection amount of either the second type of functional liquid or the third type of functional liquid ejected per unit area is different from each other. According to such a test pattern, even when a plurality of types of functional liquids are to be ejected, the user can easily grasp an appropriate upper limit value of the ejection amount of the colored liquid and an appropriate upper limit value of the ejection amount of each functional liquid.

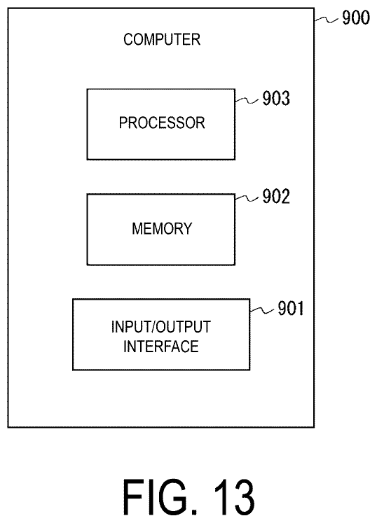

Although the embodiment and the modified examples thereof have been described above, the process of the printing apparatus 100 may be executed by a computer included in the printing apparatus 100. Note that the computer may be configured as a system on a chip (SoC). FIG. 13 is a block diagram illustrating an example of a hardware configuration of a computer 900 included in the printing apparatus 100. As illustrated in FIG. 13, the computer 900 includes, for example, an input/output interface 901, a memory 902, and a processor 903.

The input/output interface 901 is used to communicate with any circuit or device. The memory 902 is configured by, for example, a combination of a volatile memory and a nonvolatile memory. The memory 902 is used to store a program executed by the processor 903, data used for various processes of the printing apparatus 100, and the like.

The processor 903 reads and executes a program from the memory 902 to perform various processes described in the above-described embodiment or modified examples, including the processes of the input reception unit 120 and the printing control unit 130. The processor 903 may be, for example, a microprocessor, a microprocessor unit (MPU), a central processing unit (CPU), or the like. In addition, the processor 903 may include a plurality of processors.

The program includes a group of commands (or software code) for causing the computer to perform one or more functions described in the embodiment when the program is read by the computer. The program may be stored in a non-transitory computer-readable medium or a tangible storage medium. By way of example, and not limitation, computer-readable media or tangible storage media include random-access memory (RAM), read-only memory (ROM), flash memory, solid-state drive (SSD) or other memory technology, CD-ROM, digital versatile disk (DVD), Blu-ray (trade name) disk or other optical disk storage, magnetic cassettes, magnetic tapes, magnetic disk storage, or other magnetic storage device. The program may be transmitted through a transitory computer-readable medium or a communication medium. By way of example and not limitation, the transitory computer-readable medium or a communication medium includes an electrical-type, an optical-type, an acoustical-type, or other types of propagation signal.

Note that the present disclosure is not limited to the above-described embodiment and the modified examples thereof, and can be appropriately changed without departing from the gist. For example, a medium on which an image is formed, that is, a medium on which printing is performed is not limited to a fabric, and may be other media such as paper. That is, the printing apparatus 100 may not necessarily be a textile printing printer. Furthermore, for example, in the above embodiment, the presence or absence of the ejection boundary smearing or the color boundary smearing in the test pattern printed on the medium is determined by the user visually, but may be determined by performing an image analysis process by a computer on an image obtained by scanning the medium on which the test pattern is printed with a scanner.

Some or all of the above embodiment and modified examples can also be described as the following supplementary notes, but are not limited to the following.

### Supplementary Note 1

A printing apparatus including:

a printing head configured to eject a colored liquid onto a medium; and

a printing control unit configured to control ejection of the colored liquid from the printing head to print a test pattern on the medium, the test pattern being for determining an upper limit value of an ejection amount of the colored liquid that is able to be ejected for printing an image, wherein

the test pattern includes at least one patch,

the patch includes a colored region to which the colored liquid is ejected and a blank region to which the colored liquid is not ejected,

the blank region has a predetermined shape and is located on an inner side of the patch, and

the colored region is arranged to surround the blank region and is adjacent to an outer side of the blank region.

### Supplementary Note 2

The printing apparatus according to Supplementary Note 1, wherein the predetermined shape is a rectangular shape.

### Supplementary Note 3

The printing apparatus according to Supplementary Note 1 or 2, wherein the test pattern includes a plurality of the patches in which an amount of the colored liquid ejected per unit area is different.

### Supplementary Note 4

The printing apparatus according to any one of Supplementary Notes 1 to 3, wherein the colored region includes a first partial region of a first color and a second partial region of a second color different from the first color, the first partial region and the second partial region being adjacent to each other.

### Supplementary Note 5

The printing apparatus according to Supplementary Note 3, wherein

the printing head is further configured to eject a functional liquid to a region same as the region to which the colored liquid is ejected,

the printing control unit controls ejection of the colored liquid and the functional liquid from the printing head to print the test pattern on the medium,

the test pattern includes

a plurality of the patches in which an amount of the functional liquid ejected per unit area is different,

the plurality of patches in which an amount of the colored liquid ejected per unit area is different are arranged side by side in a first order in a first direction,

the first order is a descending order or an ascending order of the amount of the colored liquid,

the plurality of patches in which an amount of the functional liquid ejected per unit area is different are arranged side by side in a second order in a second direction orthogonal to the first direction, and

the second order is a descending order or an ascending order of the amount of the functional liquid.

### Supplementary Note 6

The printing apparatus according to any one of Supplementary Notes 1 to 5, wherein

the patch further includes a blank line to which the colored liquid is not ejected, and

the colored region is adjacent to both sides of the blank line.

### Supplementary Note 7

The printing apparatus according to any one of Supplementary Notes 1 to 6, wherein

the patch further includes a colored line to which the colored liquid is ejected,

a color of the colored line is different from a color of the colored region, and

the colored region is adjacent to both sides of the colored line.

### Supplementary Note 8

A printing method including:

controlling ejection of a colored liquid from a printing head configured to eject the colored liquid onto a medium; and

printing a test pattern on the medium, the test pattern being for determining an upper limit value of an ejection amount of the colored liquid that is able to be ejected for printing an image, wherein

the test pattern includes at least one patch,

the patch includes a colored region to which the colored liquid is ejected and a blank region to which the colored liquid is not ejected,

the blank region has a predetermined shape and is located on an inner side of the patch, and

the colored region is arranged to surround the blank region and is adjacent to an outer side of the blank region.

### Supplementary Note 9

A test pattern for determining an upper limit value of an ejection amount of a colored liquid that is able to be ejected for printing an image, wherein

the test pattern includes at least one patch,

the patch includes a colored region to which the colored liquid is ejected and a blank region to which the colored liquid is not ejected,

the blank region has a predetermined shape and is located on an inner side of the patch, and

the colored region is arranged to surround the blank region and is adjacent to an outer side of the blank region.

What is claimed is:

1. A printing apparatus comprising:
a printing head configured to eject a colored liquid onto a medium; and
a printing control unit configured to control ejection of the colored liquid from the printing head to print a test pattern on the medium, the test pattern being for determining an upper limit value of an ejection amount of the colored liquid that is able to be ejected for printing an image, wherein
the test pattern includes at least one patch,
the patch includes a colored region to which the colored liquid is ejected and a blank region to which the colored liquid is not ejected,
the blank region has a predetermined shape and is located on an inner side of the patch, and
the colored region is arranged to surround the blank region and is adjacent to an outer side of the blank region.

2. The printing apparatus according to claim 1, wherein the predetermined shape is a rectangular shape.

3. The printing apparatus according to claim 1, wherein the test pattern includes a plurality of the patches in which an amount of the colored liquid ejected per unit area is different.

4. The printing apparatus according to claim 1, wherein the colored region includes a first partial region of a first color and a second partial region of a second color different from the first color, the first partial region and the second partial region being adjacent to each other.

5. The printing apparatus according to claim 3, wherein
the printing head is further configured to eject a functional liquid to a region same as the region to which the colored liquid is ejected,
the printing control unit controls ejection of the colored liquid and the functional liquid from the printing head to print the test pattern on the medium,
the test pattern includes
a plurality of the patches in which an amount of the functional liquid ejected per unit area is different,
the plurality of patches in which an amount of the colored liquid ejected per unit area is different are arranged side by side in a first order in a first direction,
the first order is a descending order or an ascending order of the amount of the colored liquid,
the plurality of patches in which an amount of the functional liquid ejected per unit area is different are arranged side by side in a second order in a second direction orthogonal to the first direction, and
the second order is a descending order or an ascending order of the amount of the functional liquid.

6. The printing apparatus according to claim 1, wherein
the patch further includes a blank line to which the colored liquid is not ejected, and
the colored region is adjacent to both sides of the blank line.

7. The printing apparatus according to claim 1, wherein
the patch further includes a colored line to which the colored liquid is ejected,
a color of the colored line is different from a color of the colored region, and
the colored region is adjacent to both sides of the colored line.

8. A printing method comprising:
controlling ejection of a colored liquid from a printing head configured to eject the colored liquid onto a medium; and
printing a test pattern on the medium, the test pattern being for determining an upper limit value of an ejection amount of the colored liquid that is able to be ejected for printing an image, wherein
the test pattern includes at least one patch,
the patch includes a colored region to which the colored liquid is ejected and a blank region to which the colored liquid is not ejected,
the blank region has a predetermined shape and is located on an inner side of the patch, and
the colored region is arranged to surround the blank region and is adjacent to an outer side of the blank region.

9. A test pattern for determining an upper limit value of an ejection amount of a colored liquid that is able to be ejected for printing an image, wherein
the test pattern includes at least one patch,
the patch includes a colored region to which the colored liquid is ejected and a blank region to which the colored liquid is not ejected,
the blank region has a predetermined shape and is located on an inner side of the patch, and
the colored region is arranged to surround the blank region and is adjacent to an outer side of the blank region.
